(19) United States
(12) Patent Application Publication
(10) Pub. No.: US 2026/0257578 A1
(43) Pub. Date: Sep. 3, 2026

(54) WIND POWER GENERATOR SET FOR ELECTRIC VEHICLE AND USE METHOD THEREOF

(71) Applicant: Jiahao Zhu, Shaoxing County (CN)

(72) Inventor: Jiahao Zhu, Shaoxing County (CN)

(21) Appl. No.: 19/259,317

(22) Filed: Jul. 3, 2025

(30) Foreign Application Priority Data
Mar. 3, 2025 (CN) 202510240394.6

(51) Int. Cl. B60L 53/52; B60L 7/10; B60L 53/57; F03D 9/25; F03D 9/32; H02K 7/18

(52) U.S. Cl. CPC B60L 53/52; B60L 7/10; B60L 53/57; F03D 9/25; F03D 9/32; H02K 7/183

(57) ABSTRACT

The present invention relates to the technical field of wind power generation, and in particular to a wind power generator set for an electric vehicle, which includes a wind turbine, a generator, an energy storage system, a control system and a shock absorbing support structure; the wind turbine is configured to capture wind energy and convert the wind energy into mechanical energy; the generator is connected to the wind turbine and configured to convert the mechanical energy into electric energy; the energy storage system is connected to the generator; and the control system is configured to monitor and adjust operation states of the wind turbine, the generator and the energy storage system. The control system monitors the wind speed and the operating state of the electric vehicle in real time, and the blade angle of the wind turbine and the load of the generator are adjusted.

### REFERENCE TO PRIOR APPLICATION

This application claims priority to Chinese Patent Application 202510240394.6, filed on Mar. 3, 2025, which is incorporated herein by reference.

### TECHNICAL FIELD

The present invention relates to the technical field of wind power generation, and in particular to a wind power generator set for an electric vehicle and a use method thereof.

### BACKGROUND

With the continuous growth of global energy demand and the improvement of environmental protection awareness, wind power generation, as a clean and renewable energy form, is increasingly valued by countries around the world. Wind power generation has become an important means to promote sustainable development. Meanwhile, the development of efficient, stable and reliable wind power generator sets for electric vehicles has become an important direction of the industry with the rapid development of the electric vehicle industry.

In the prior art, the wind power generator set technology for electric vehicles has the following problems: (1) The battery life of electric vehicles is insufficient. Once the battery is exhausted, the vehicle may only be powered by parking for several hours for recharging, which greatly limits the rapid development of electric vehicles. (2) Small wind turbine generators cannot automatically make adjustment according to the wind direction during use, so that the position of a rotating shaft is damaged due to too high rotating speed when wind power is too high, and the use of the equipment is influenced. (3) Some generators also have problems such as low efficiency, poor stability, and high maintenance costs.

Therefore, to address the problems of inability to automatically adjust according to wind direction during use and having low efficiency and poor stability, a wind power generator set for an electric vehicle and a use method thereof are designed.

### SUMMARY

To address the problems of inability to automatically adjust according to wind direction during use and having low efficiency and poor stability, the present invention provides the following technical solutions.

A wind power generator set for an electric vehicle includes a wind turbine, a generator, an energy storage system, a control system and a shock absorbing support structure;
the wind turbine is configured to capture wind energy and convert the wind energy into mechanical energy;
the generator is connected to the wind turbine and configured to convert the mechanical energy into electric energy;
the energy storage system is connected to the generator and configured to store the electric energy;
the control system is configured to monitor and adjust operation states of the wind turbine, the generator and the energy storage system; and
the shock absorbing support structure is mounted at connections of a vehicle roof, a vehicle side surface, a vehicle tail, a vehicle bottom or a carriage, and is configured to fix the wind turbine and the generator, ensuring stability of the wind turbine and the generator during operation of the electric vehicle and reducing vibration and noise of the wind turbine and the generator during operation.

Preferably, the wind turbine is a vertical axis wind turbine, a blade structure of the wind turbine is imitated from bird wings or fish fins, and a blade of the wind turbine is made of carbon fiber or glass fiber.

Preferably, the energy storage system includes a lithium-ion battery pack and a supercapacitor.

Preferably, the energy storage system further includes a kinetic energy recovery device configured to recover and store energy when the electric vehicle brakes.

Preferably, the control system includes a wind speed sensor, a rotation speed sensor, a voltage sensor and a controller based on an artificial intelligence algorithm.

Preferably, the control system further includes an adaptive control module configured to automatically adjust a blade angle of the wind turbine and a load of the generator according to real-time wind speed and electric vehicle operating state.

Preferably, the shock absorbing support structure includes a bottom plate and a support plate, a rotating plate is rotatably connected inside the support plate, an inner core plate is fixedly connected to an inner side of the rotating plate, a mounting plate is fixedly connected to an upper end of the inner core plate, guide seats evenly distributed in an annular manner are fixedly connected to an upper end of the bottom plate, an upper end of a bottom in the guide seat is fixedly connected to a first magnet, an upper end of the first magnet is magnetically connected to a second magnet, an upper end of the second magnet is fixedly connected to a sliding block, an inserting column inserted into an inner side of the sliding block is fixedly connected in the guide seat, an outer side of the inserting column is provided with a damping reset spring, an upper end of the sliding block is fixedly connected to a U-shaped frame, a lower end of the inner core plate is fixedly connected to another U-shaped frames evenly distributed in an annular manner, a damping shock absorber is rotatably connected between the two U-shaped frames, a lower end of the support plate is fixedly connected to an L-shaped support, an upper end of the L-shaped support is fixedly connected to a motor, a driving gear is mounted on an outer side of an output shaft of the motor, a driven gear meshing with the driving gear is mounted at the lower end of the inner core plate, an annular guide rail is fixedly connected to an upper end of the support plate, pulleys evenly distributed in an annular manner are fixedly connected to a lower end of the mounting plate, the pulley is slidably connected in the annular guide rail, and a lower end of the bottom plate is fixedly connected to an anti-slip pad.

A use method of the wind power generator set for the electric vehicle includes the following steps:
Step I: the bottom plate is mounted at connections of the vehicle roof, the vehicle side surface, the vehicle tail, the vehicle bottom or the carriage, the wind turbine and the generator are fixed on the mounting plate, the anti-slip pad may increase a friction between the electric vehicle and the bottom plate, the motor at the upper end of the L-shaped support is started according to change of wind direction, the rotating plate, the inner core plate and the mounting plate are driven to rotate under the action of the driving gear and the driven gear, the pulley at the lower end of the mounting plate slides in the annular guide rail, the damping shock absorber between the two U-shaped frames plays a shock absorption role, the sliding block in the guide seat slides on the outer side of the inserting column, the damping reset spring is compressed, a resistance of the sliding block is increased under the action of the first magnet and the second magnet, and shock absorption is performed again;
Step II: the wind power generator set for the electric vehicle is started, the control system is initialized and detects wind speed, rotation speed and voltage parameters, the wind turbine captures wind energy and converts the wind energy into mechanical energy, and the generator converts the mechanical energy into electric energy;
Step III: the electric energy is stored in the energy storage system or directly used in a motor of the electric vehicle;
Step IV: the control system monitors the wind speed and an operating state of the electric vehicle in real time, and adjusts a blade angle of the wind turbine and a load of the generator;
Step V: when the electric vehicle brakes, the kinetic energy recovery device converts braking energy into electric energy and stores the electric energy in the energy storage system; and
Step VI: when there is no wind or the wind energy is insufficient, the energy storage system releases the stored electric energy to ensure normal operation of the electric vehicle.

Preferably, in the step IV, the control system predicts changes in the wind speed based on an artificial intelligence algorithm, and adjusts operating parameters of the wind turbine in advance, and the specific steps are as follows:
(1) collecting historical wind speed data, including wind direction, temperature, motor speed, pitch angle, and cumulative daily power generation, and performing normalization processing on the data;
(2) selecting an FCBF algorithm for feature selection, predicting the wind speed based on an EPSO algorithm optimized RBF model, and training the model by using the historical data;
(3) predicting wind speed in a period of time in the future by using the trained model, and determining a trend and range of the wind speed changes according to prediction results;
(4) adjusting the operating parameters of the wind turbine in advance according to the wind speed prediction results;
if an increase in the wind speed is predicted, increasing the blade angle and the load of the generator in advance; and

If a reduction in the wind speed is predicted, reducing the blade angle and the load of the generator.

Preferably, in the step VI, the energy storage system releases the electric energy by preferentially using a supercapacitor.

The present invention has the beneficial effects that: the control system monitors the wind speed and the operating state of the electric vehicle in real time, the blade angle of the wind turbine and the load of the generator are adjusted, and automatic adjustment is achieved by the wind direction, so that the situation that the position of the rotating shaft is damaged due to too high rotating speed when wind power is too high and the use of the equipment is influenced is avoided, the wind energy generated when wind resistance during driving flows through the wind power generator set is used to meet the requirement of driving endurance of the vehicle, the battery energy is effectively supplemented in time, and the endurance mileage and the practicability of the electric vehicle are improved. The wind energy generated during driving may be efficiently converted into electric energy in real time by the wind power generator set for the electric vehicle, so that the battery energy of the electric vehicle is supplemented, the endurance mileage of the electric vehicle is significantly increased, and the practicability of the electric vehicle is greatly improved.

### BRIEF DESCRIPTION OF DRAWINGS

FIG. 1 is a schematic diagram of a frame structure of a wind power generator set for an electric vehicle according to the present invention;

FIG. 2 is a schematic diagram of a first three-dimensional structure of a shock absorbing support structure in a wind power generator set for an electric vehicle according to the present invention;

FIG. 3 is a schematic diagram of a second three-dimensional structure of a shock absorbing support structure in a wind power generator set for an electric vehicle according to the present invention;

FIG. 4 is a schematic diagram of a three-dimensional structure of a support plate and a mounting plate of a shock absorbing support structure in a wind power generator set for an electric vehicle according to the present invention;

FIG. 5 is a schematic diagram of a three-dimensional structure of a guide seat and a sliding block of a shock absorbing support structure in a wind power generator set for an electric vehicle according to the present invention; and

FIG. 6 is a schematic diagram of a three-dimensional structure of a motor and an inner core plate of a shock absorbing support structure in a wind power generator set for an electric vehicle according to the present invention.

Description of the reference numerals: 1. bottom plate; 2. support plate; 3. rotating plate; 4. inner core plate; 5. mounting plate; 6. guide seat; 7. first magnet; 8. second magnet; 9. Sliding block; 10. inserting column; 11. damping reset spring; 12. U-shaped frame; 13. damping shock absorber; 14. L-shaped support; 15. motor; 16. driving gear; 17. driven gear; 18. annular guide rail; 19. pulley; and 20. anti-slip pad.

### DETAILED DESCRIPTION OF EMBODIMENTS

The present invention will be further described below in conjunction with the accompanying drawings and embodiments.

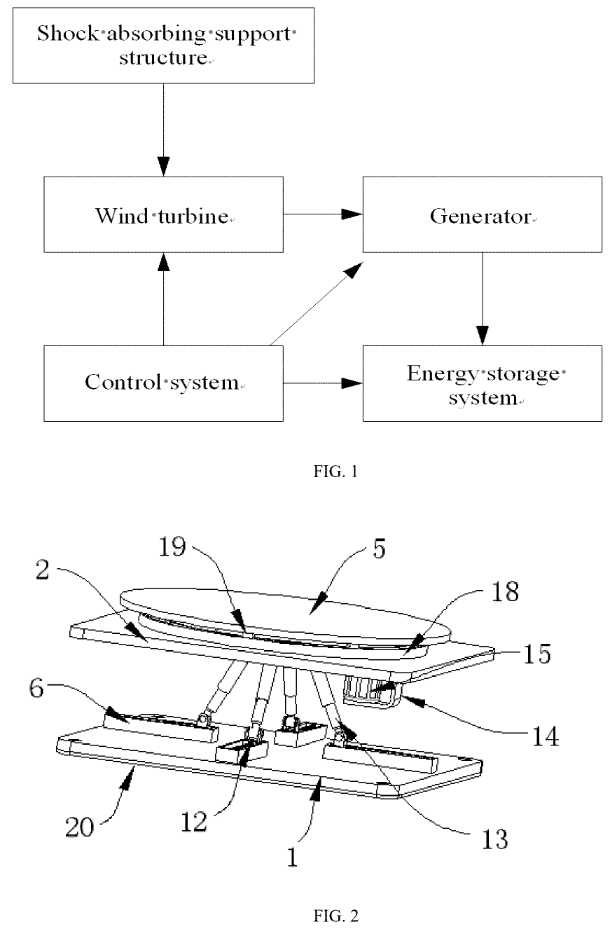

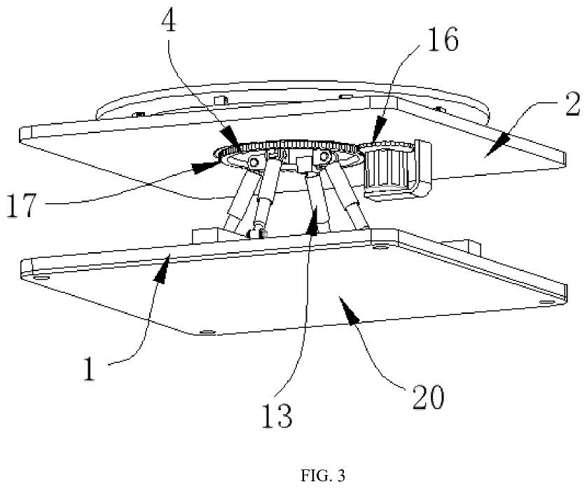

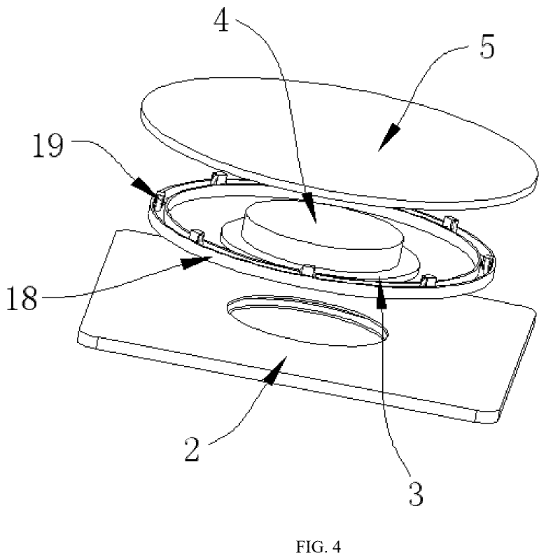

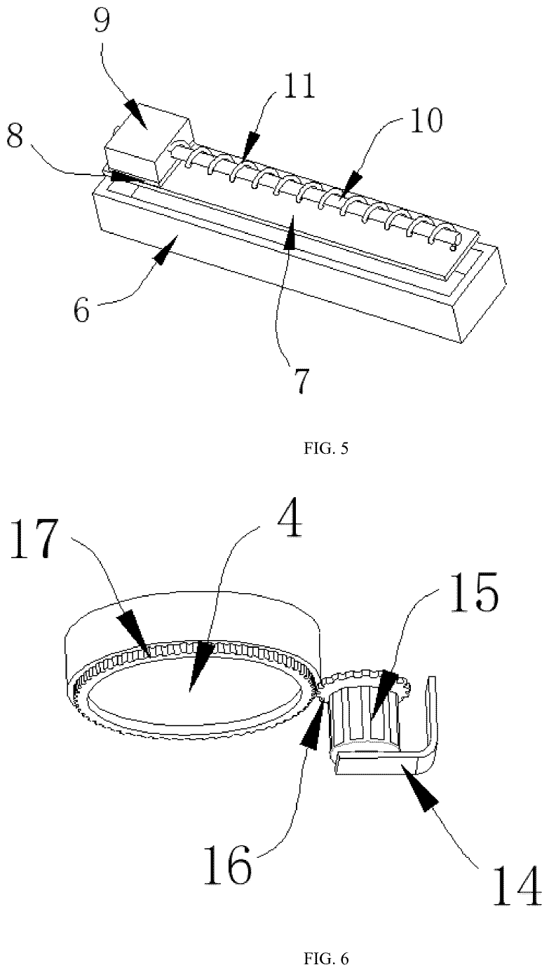

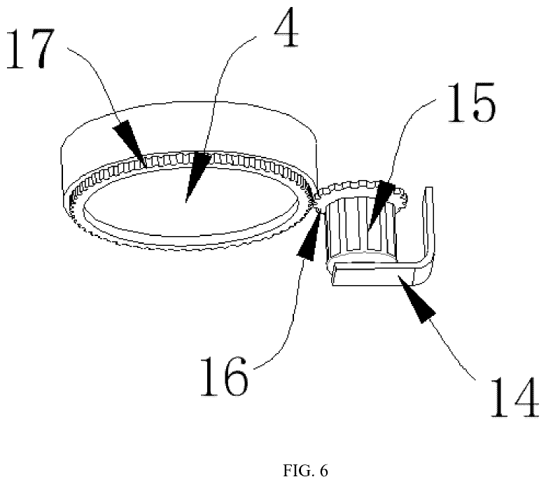

Referring to FIGS. 1 to 6, the present invention provides an embodiment: a wind power generator set for an electric vehicle includes a wind turbine, a generator, an energy storage system, a control system and a shock absorbing support structure; the wind turbine is configured to capture wind energy and convert the wind energy into mechanical energy;
the generator is connected to the wind turbine and configured to convert the mechanical energy into electric energy;
the energy storage system is connected to the generator and configured to store the electric energy;
the control system is configured to monitor and adjust operation states of the wind turbine, the generator and the energy storage system; and
the shock absorbing support structure is mounted at connections of a vehicle roof, a vehicle side surface, a vehicle tail, a vehicle bottom or a carriage, and is configured to fix the wind turbine and the generator, ensuring stability of the wind turbine and the generator during operation of the electric vehicle and reducing vibration and noise of the wind turbine and the generator during operation.

The wind turbine is a vertical axis wind turbine, a blade structure of the wind turbine is imitated from bird wings or fish fins, and a blade of the wind turbine is made of carbon fiber or glass fiber; and the energy storage system includes a lithium-ion battery pack and a supercapacitor.

Meanwhile, the energy storage system further includes a kinetic energy recovery device configured to recover and store energy when the electric vehicle brakes, the control system includes a wind speed sensor, a rotation speed sensor, a voltage sensor and a controller based on an artificial intelligence algorithm, and the control system further includes an adaptive control module configured to automatically adjust a blade angle of the wind turbine and a load of the generator according to real-time wind speed and electric vehicle operating state.

In addition, the shock absorbing support structure includes a bottom plate 1 and a support plate 2, a rotating plate 3 is rotatably connected inside the support plate 2, an inner core plate 4 is fixedly connected to an inner side of the rotating plate 3, a mounting plate 5 is fixedly connected to an upper end of the inner core plate 4, guide seats 6 evenly distributed in an annular manner are fixedly connected to an upper end of the bottom plate 1, an upper end of a bottom in the guide seat 6 is fixedly connected to a first magnet 7, an upper end of the first magnet 7 is magnetically connected to a second magnet 8, an upper end of the second magnet 8 is fixedly connected to a sliding block 9, an inserting column 10 inserted into an inner side of the sliding block 9 is fixedly connected in the guide seat 6, an outer side of the inserting column 10 is provided with a damping reset spring 11, an upper end of the sliding block 9 is fixedly connected to a U-shaped frame 12, a lower end of the inner core plate 4 is fixedly connected to another U-shaped frames 12 evenly distributed in an annular manner, a damping shock absorber 13 is rotatably connected between the two U-shaped frames 12, a lower end of the support plate 2 is fixedly connected to an L-shaped support 14, an upper end of the L-shaped support 14 is fixedly connected to a motor 15, a driving gear 16 is mounted on an outer side of an output shaft of the motor 15, a driven gear 17 meshing with the driving gear 16 is mounted at the lower end of the inner core plate 4, an annular guide rail 18 is fixedly connected to an upper end of the support plate 2, pulleys 19 evenly distributed in an annular manner are fixedly connected to a lower end of the mounting plate 5, the pulley 19 is slidably connected in the annular guide rail 18, and a lower end of the bottom plate 1 is fixedly connected to an anti-slip pad 20.

A use method of the wind power generator set for the electric vehicle includes the following steps:
Step I: the bottom plate 1 is mounted at connections of the vehicle roof, the vehicle side surface, the vehicle tail, the vehicle bottom or the carriage, the wind turbine and the generator are fixed on the mounting plate 5, the anti-slip pad 20 may increase a friction between the electric vehicle and the bottom plate 1, the motor 15 at the upper end of the L-shaped support 14 is started according to change of wind direction, the rotating plate 3, the inner core plate 4 and the mounting plate 5 are driven to rotate under the action of the driving gear 16 and the driven gear 17, the pulley 19 at the lower end of the mounting plate 5 slides in the annular guide rail 18, the damping shock absorber 13 between the two U-shaped frames 12 plays a shock absorption role, the sliding block 9 in the guide seat 6 slides on the outer side of the inserting column 10, the damping reset spring 11 is compressed, a resistance of the sliding block 9 is increased under the action of the first magnet 7 and the second magnet 8, and shock absorption is performed again;
Step II: the wind power generator set for the electric vehicle is started, the control system is initialized and detects wind speed, rotation speed and voltage parameters, the wind turbine captures wind energy and converts the wind energy into mechanical energy, and the generator converts the mechanical energy into electric energy;
Step III: the electric energy is stored in the energy storage system or directly used in a motor of the electric vehicle;
Step IV: the control system monitors the wind speed and an operating state of the electric vehicle in real time, and adjusts a blade angle of the wind turbine and a load of the generator;

Step V: when the electric vehicle brakes, the kinetic energy recovery device converts braking energy into electric energy and stores the electric energy in the energy storage system; and
Step VI: when there is no wind or the wind energy is insufficient, the energy storage system releases the stored electric energy to ensure normal operation of the electric vehicle.

In the step IV, the control system predicts changes in the wind speed based on an artificial intelligence algorithm, and adjusts operating parameters of the wind turbine in advance, and the specific steps are as follows:
(1) collecting historical wind speed data, including wind direction, temperature, motor speed, pitch angle, and cumulative daily power generation, and performing normalization processing on the data;
(2) selecting an FCBF algorithm for feature selection, predicting the wind speed based on an EPSO algorithm optimized RBF model, and training the model by using the historical data;
(3) predicting wind speed in a period of time in the future by using the trained model, and determining a trend and range of the wind speed changes according to prediction results;
(4) adjusting the operating parameters of the wind turbine in advance according to the wind speed prediction results;
if an increase in the wind speed is predicted, increasing the blade angle and the load of the generator in advance; and
if a reduction in the wind speed is predicted, reducing the blade angle and the load of the generator.

Meanwhile, in the step VI, the energy storage system releases the electric energy by preferentially using a supercapacitor.

According to the foregoing steps, the control system monitors the wind speed and the operating state of the electric vehicle in real time, the blade angle of the wind turbine and the load of the generator are adjusted, and automatic adjustment is achieved by the wind direction, so that the situation that the position of the rotating shaft is damaged due to too high rotating speed when wind power is too high and the use of the equipment is influenced is avoided, the wind energy generated when wind resistance during driving flows through the wind power generator set is used to meet the requirement of driving endurance of the vehicle, the battery energy is effectively supplemented in time, the endurance mileage of the electric vehicle is significantly improved to solve the problems of inability to automatically adjust according to wind direction during use, low efficiency and poor stability.

The embodiments of the present invention have been described in detail with reference to the accompanying drawings, however, the present invention is not limited to the foregoing embodiments. Various changes may be made within the knowledge of those skilled in the art without departing from the gist of the present invention.

What is claimed is:

1. A wind power generator set for an electric vehicle, comprising: a wind turbine, a generator, an energy storage system, a control system and a shock absorbing support structure; wherein
the wind turbine is configured to capture wind energy and convert the wind energy into mechanical energy;
the generator is connected to the wind turbine and configured to convert the mechanical energy into electric energy;
the energy storage system is connected to the generator and configured to store the electric energy;
the control system is configured to monitor and adjust operation states of the wind turbine, the generator and the energy storage system; and
the shock absorbing support structure is mounted at connections of a vehicle roof, a vehicle side surface, a vehicle tail, a vehicle bottom or a carriage, and is configured to fix the wind turbine and the generator, ensuring stability of the wind turbine and the generator during operation of the electric vehicle and reducing vibration and noise of the wind turbine and the generator during operation.

2. The wind power generator set for the electric vehicle according to claim 1, wherein the wind turbine is a vertical axis wind turbine, a blade structure of the wind turbine is imitated from bird wings or fish fins, and a blade of the wind turbine is made of carbon fiber or glass fiber.

3. The wind power generator set for the electric vehicle according to claim 2, wherein the energy storage system comprises a lithium-ion battery pack and a supercapacitor.

4. The wind power generator set for the electric vehicle according to claim 3, wherein the energy storage system further comprises a kinetic energy recovery device configured to recover and store energy when the electric vehicle brakes.

5. The wind power generator set for the electric vehicle according to claim 4, wherein the control system comprises a wind speed sensor, a rotation speed sensor, a voltage sensor and a controller based on an artificial intelligence algorithm.

6. The wind power generator set for the electric vehicle according to claim 5, wherein the control system further comprises an adaptive control module configured to automatically adjust a blade angle of the wind turbine and a load of the generator according to real-time wind speed and electric vehicle operating state.

7. The wind power generator set for the electric vehicle according to claim 6, wherein the shock absorbing support structure comprises a bottom plate (1) and a support plate (2), a rotating plate (3) is rotatably connected inside the support plate (2), an inner core plate (4) is fixedly connected to an inner side of the rotating plate (3), a mounting plate (5) is fixedly connected to an upper end of the inner core plate (4), guide seats (6) evenly distributed in an annular manner are fixedly connected to an upper end of the bottom plate (1), an upper end of a bottom in the guide seat (6) is fixedly connected to a first magnet (7), an upper end of the first magnet (7) is magnetically connected to a second magnet (8), an upper end of the second magnet (8) is fixedly connected to a sliding block (9), an inserting column (10) inserted into an inner side of the sliding block (9) is fixedly connected in the guide seat (6), an outer side of the inserting column (10) is provided with a damping reset spring (11), an upper end of the sliding block (9) is fixedly connected to a U-shaped frame (12), a lower end of the inner core plate (4) is fixedly connected to another U-shaped frames (12) evenly distributed in an annular manner, a damping shock absorber (13) is rotatably connected between the two U-shaped frames (12), a lower end of the support plate (2) is fixedly connected to an L-shaped support (14), an upper end of the L-shaped support (14) is fixedly connected to a motor (15), a driving gear (16) is mounted on an outer side of an output shaft of the motor (15), a driven gear (17) meshing with the driving gear (16) is mounted at the lower end of the inner core plate (4), an annular guide rail (18) is fixedly connected to an upper end of the support plate (2), pulleys (19) evenly distributed in an annular manner are fixedly connected to a lower end of the mounting plate (5), the pulley (19) is slidably connected in the annular guide rail (18), and a lower end of the bottom plate (1) is fixedly connected to an anti-slip pad (20).

8. A use method of the wind power generator set for the electric vehicle according to claim 7, comprising the following steps:
Step I: the bottom plate (1) is mounted at connections of the vehicle roof, the vehicle side surface, the vehicle tail, the vehicle bottom or the carriage, the wind turbine and the generator are fixed on the mounting plate (5), the anti-slip pad (20) may increase a friction between the electric vehicle and the bottom plate (1), the motor (15) at the upper end of the L-shaped support (14) is started according to change of wind direction, the rotating plate (3), the inner core plate (4) and the mounting plate (5) are driven to rotate under the action of the driving gear (16) and the driven gear (17), the pulley (19) at the lower end of the mounting plate (5) slides in the annular guide rail (18), the damping shock absorber (13) between the two U-shaped frames (12) plays a shock absorption role, the sliding block 9 in the guide seat 6 slides on the outer side of the inserting column (10), the damping reset spring (11) is compressed, a resistance of the sliding block (9) is increased under the action of the first magnet (7) and the second magnet (8), and shock absorption is performed again;
Step II: the wind power generator set for the electric vehicle is started, the control system is initialized and detects wind speed, rotation speed and voltage parameters, the wind turbine captures wind energy and converts the wind energy into mechanical energy, and the generator converts the mechanical energy into electric energy;
Step III: the electric energy is stored in the energy storage system or directly used in a motor of the electric vehicle;
Step IV: the control system monitors the wind speed and an operating state of the electric vehicle in real time, and adjusts a blade angle of the wind turbine and a load of the generator;
Step V: when the electric vehicle brakes, the kinetic energy recovery device converts braking energy into electric energy and stores the electric energy in the energy storage system; and
Step VI: when there is no wind or the wind energy is insufficient, the energy storage system releases the stored electric energy to ensure normal operation of the electric vehicle.

9. The use method of the wind power generator set for the electric vehicle according to claim 8, wherein in the step IV, the control system predicts changes in the wind speed based on an artificial intelligence algorithm, and adjusts operating parameters of the wind turbine in advance, and the specific steps are as follows:
(1) collecting historical wind speed data, comprising wind direction, temperature, motor speed, pitch angle, and cumulative daily power generation, and performing normalization processing on the data;
(2) selecting an FCBF algorithm for feature selection, predicting the wind speed based on an EPSO algorithm optimized RBF model, and training the model by using the historical data;
(3) predicting wind speed in a period of time in the future by using the trained model, and determining a trend and range of the wind speed changes according to prediction results;
(4) adjusting the operating parameters of the wind turbine in advance according to the wind speed prediction results;
if an increase in the wind speed is predicted, increasing the blade angle and the load of the generator in advance; and
if a reduction in the wind speed is predicted, reducing the blade angle and the load of the generator.

10. The use method of the wind power generator set for the electric vehicle according to claim 8, wherein in the step VI, the energy storage system releases the electric energy by preferentially using a supercapacitor.
